(19) United States
(12) Patent Application Publication
(10) Pub. No.: US 2010/0127888 A1
(43) Pub. Date: May 27, 2010

(54) USING POCKET DEVICE TO SURVEY, MONITOR, AND CONTROL PRODUCTION DATA IN REAL TIME

(75) Inventors: Min He, Beijing (CN); Chen Lin, Beijing (CN); YinLi Wang, Beijing (CN)

Correspondence Address: Schlumberger Technology Corporation/Osha Liang;Mr. Bryan Galloway, Managing IP Counsel, 5599 San Felipe, Suite 100, HOUSTON, TX, 77056, US

(73) Assignees: SCHLUMBERGER CANADA LIMITED, Alberta (CA); SCHLUMBERGER TECHNOLOGY CORPORATION, Houston, TX (US); SERVICES PETROLIERS SCHLUMBERGER, Paris (FR); SCHLUMBERGER HOLDINGS LIMITED, Tortola, B.V.I. (NL); SCHLUMBERGER TECHNOLOGY B.V., The Hague (NL); PRAD RESEARCH AND DEVELOPMENT LIMITED, Tortola, B.V.I. (NL)

(21) Appl. No.: 12/323,960

(22) Filed: Nov. 26, 2008

(51) Int. Cl. G01V 3/00

(52) U.S. Cl. 340/853.2

(57) ABSTRACT

A system for real-time data surveillance in an oilfield operation includes a data collection system deployed at a well site for collecting oilfield data; an office-based computer system for storing and analyzing the oilfield data; a portable device, wherein the portable device includes at least one program for communicating with the office-based computer system, for surveying the oilfield data stored in the office-based computer system, and for causing the office-based computer system to perform a process implemented on the office-based computer system; and a communication system providing communication links among the data collection system, the office-based computer system, and the portable device.

### BACKGROUND OF INVENTION

1. Field of the Invention

The invention relates generally to data surveillance in oilfield operations, and more particularly to the apparatus and the methods of using such apparatus to perform data surveillance in real time.

2. Background Art

Wells for the production of hydrocarbons should be carefully monitored to prevent catastrophic mishaps. In addition, the production of a producing well should be monitored and controlled to maximize the production over time. Producing hydrocarbons too quickly from one well in a producing formation relative to other wells in the producing formation (of a single reservoir) may result in stranding hydrocarbons in the formation. For example, improper production may separate an oil pool into multiple portions. In such cases, additional wells must be drilled to produce the oil from the separate pools. Unfortunately, either legal restrictions or economic considerations may not allow another well to be drilled thereby stranding the pool of oil.

Besides monitoring certain field and production data to prevent economic waste of an oilfield, an oilfield's production efficiencies may be maximized by monitoring the production parameters of multiple wells for a given field. For example, if field pressure is dropping for one well in an oilfield more quickly than for other wells, the production rate of that one well might be reduced. Alternatively, the production rate of the other wells might be increased. The manner of controlling production rates for different wells for one field is generally known. At issue, however, is obtaining the oilfield parameters in time.

FIG. 1 shows a schematic illustrating a conventional production well. As shown, a rig 108 may be constructed on the surface 112 above a well 104 penetrating an earth formation. The well 104 is lined with a casing 114. In the well 104, a downhole unit 208 is disposed by attaching it to one end of the production string 212. The downhole unit 208 may include various equipment for the production of hydrocarbons from the well, such as a submersible pump, valves, and other devices. In addition, the downhole unit 208 typically also includes communication devices and sensors to measure and monitor production parameters. In some operations, a remote sensor 204 may also be deployed into a subsurface formation to monitor the formation parameters. The remote sensor 204 may communicate with the downhole unit 208.

The remote sensor 204 and the sensors in the downhole unit 208 provide measurements of various parameters important for the production operations. These parameters are transmitted to the wellhead unit 116, which is in communication with a surface processor 110. The surface processor 110, for example, may include a control and monitor unit 220 and a communication unit 224. The communication unit 224 may send the data to a remote office for processing, monitoring, and decision making.

The production operation parameters allow oilfield operators to continually monitor production data such as flow rates, pressures, and artificial lift performance to optimize hydrocarbon recovery. Based on the results obtained from the production data analysis, the operators can make decisions and take actions to optimize production. Shortening the time between data acquisition and decision making means that the operator not only can react more quickly to production alarm (hence improve asset profitability), but also can predict the future production performance (and thus plan ahead to optimize future operations).

Advances in data transmission and computer technologies allow the production systems to be monitored, validated, and controlled with increasing efficiency. In addition to data transmission, production monitoring and control systems generally require two different types of computer components. First, an office-based component is required for user security control, alarm-and-alert management, data storage, and business-process management. These systems, which also compute key performance indicators and trend histories, may be based on laptop or desktop personal computers. Second, a portable component is required to verify alerts and notifications in the field. Personal pocket devices, such as hand held computers, smart phones, and the like, are the technology of choice for this function.

The current systems provide a workflow loop that starts with production data monitoring and transmission from the field, to data storage, manipulation, decision making, and instruction transmission on office-based PC systems, to production alarm notices on pocket devices in the field, and finally coming back again to monitoring and transmission. Obviously, the more efficient this workflow loop is, the greater the potential of the system would have in maximizing the hydrocarbon recovery.

FIG. 2 shows a typical workflow 20 for real time production monitoring. As shown, downhole and surface production data are obtained at well site 21. These data are transmitted via a communication system 22 to an office computer system 23. The office computer system 23 may perform various functions, such as user security control, alarm and alert management, storage and business process management, computation of key performance indicators, and production trend history, among others.

Based on the alarm and alert management set up, the computer system 23 may send simple messages to a field pocket device 24 to notify the field user and/or ask for validation. Because the field user of the current pocket device 24 cannot visualize the data, the user can only validate the data and then transmit the data back to the office-based operator 25 for survey monitoring and control functions. In this workflow, the pocket device 24 functions only as an alert notification and confirmation device, and, therefore, requires additional communication with office-based operator 25 to perform survey, monitor, and control functions. This approach adds time and complexity to the overall workflow.

As a result, the current devices have reduced usefulness in data surveillance. They produce slow response to production alarms, which may delay corrective actions and increase operational costs. It may also slow down the process to control the production devices and, thus, prolong production downtime causing profit losses to the clients. Because of the complex verification steps for production alarms, the current system requires extra time and human resource to address a simple alarm. In addition, it is difficulty to customize different visualization for different devices based on the screen resolution. Therefore, there remains a need for better systems and methods for data surveillance in oilfield operations.

### SUMMARY OF INVENTION

One aspect of the invention relates to systems for real-time data surveillance in an oilfield operation. A system in accordance with one embodiment of the invention includes a data collection system deployed at a well site for collecting oilfield data; an office-based computer system for storing and analyzing the oilfield data; a portable device, wherein the portable device includes at least one program for communicating with the office-based computer system, for surveying the oilfield data stored in the office-based computer system, and for causing the office-based computer system to perform a process implemented on the office-based computer system; and a communication system providing communication links among the data collection system, the office-based computer system, and the portable device.

Another aspect of the invention relates to methods for real-time data surveillance in an oilfield operation. A method in accordance with one embodiment of the invention includes receiving an alarm message on a portable device, wherein the alarm message is sent from an office-based computer system; interrogating, using the portable device, a database stored in the office-based computer system; sending from the handheld device, based on results from the interrogating, a response from the portable device to a well site to control the oilfield operation or to the office-based computer system.

Other aspects and advantages of the invention will be apparent from the following description and the appended claims.

### BRIEF DESCRIPTION OF DRAWINGS

FIG. 1 shows a schematic of a oil rig with a tubing and downhole tools disposed in a well penetrating a formation.

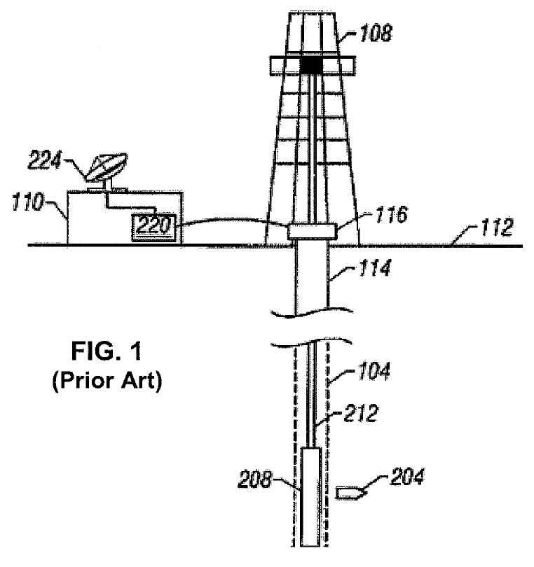

FIG. 2 shows a conventional workflow for monitoring production data.

FIG. 3 shows a workflow for monitoring production data, which may be performed in real time and at any location, in accordance with one embodiment of the invention.

FIG. 4 shows a flow chart illustrating processes involved in workflow control using a pocket device to survey, monitor and control the production data in real time in accordance with one embodiment of the present invention.

### DETAILED DESCRIPTION

Embodiments of the invention relate to systems and methods for surveying, monitoring, and controlling oilfield production in real time. Embodiments of the invention can greatly increase the efficiency and safety of oilfield production by allowing surveillance, monitor, and control in real time and at anywhere using pocket devices. Specifically, embodiments of the invention integrate alarm notification receiver and production data surveillance into pocket devices. This approach gives the pocket devices (portable devices) more functions and improve the workflow.

Some features of embodiments of the invention may include: (1) workflow of production data in “real time and anywhere”; (2) using pocket devices to survey, monitor and control the production data in real time; (3) pocket devices provide both notification receiver role and data surveillance roles; (4) the systems for monitoring and controlling oilfield operation may be alarm-driven.

While the following examples use production wells to illustrate embodiments of the invention, one skilled in the art would appreciate that these systems and methods may also be used to survey, monitor, or control other oilfield operations. Therefore, the following examples are intended for illustrations only.

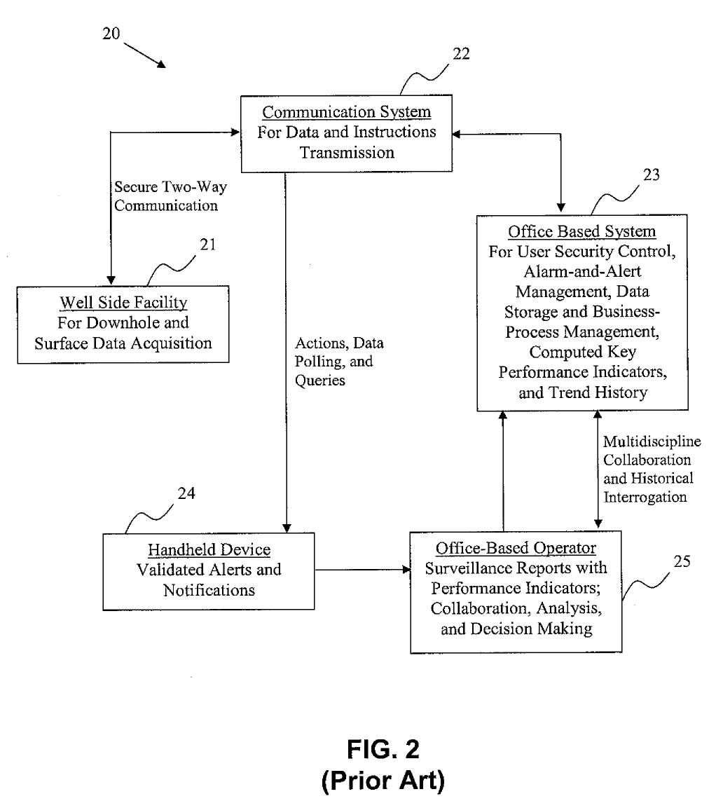

As noted above, in conventional oilfield production workflow monitoring/control systems, pocket devices are used only as alert notification and confirmation devices. In these roles, the pocket devices are merely receivers and transmitters of simple messages. Because these devices cannot perform surveillance, monitoring, and control functions, another office-based system and operator (shown as 25 in FIG. 2) are required to perform these more demanding functions—e.g., surveillance, analysis, and decision making. This approach severely limits the usefulness of the current systems because of the time and complexity involved in the overall workflow.

In contrast, workflows of the invention are designed to have more functions configured to be executable by the handheld devices (or portable devices) available to the field personnel. Specifically, a pocket device in accordance with embodiments of the invention can provide both notification receiver role (as in conventional workflow) and the data surveillance role. By assigning more functions to the handheld devices, embodiments of the invention can increase the efficiencies of monitoring and control of oilfield operations. As a result, embodiments of the invention are capable of providing workflow of production data in real time and anywhere.

In accordance with embodiments of the invention, a system or method using a pocket device to survey, monitor and control production data in real time may contain the following basic elements: (1) a workflow, which guides how to survey, monitor, and control production data on pocket device in real time; (2) a structure definition, which describes how the workflow is organized; and (3) a mechanism, which is used to customize the contents in different screen resolution device.

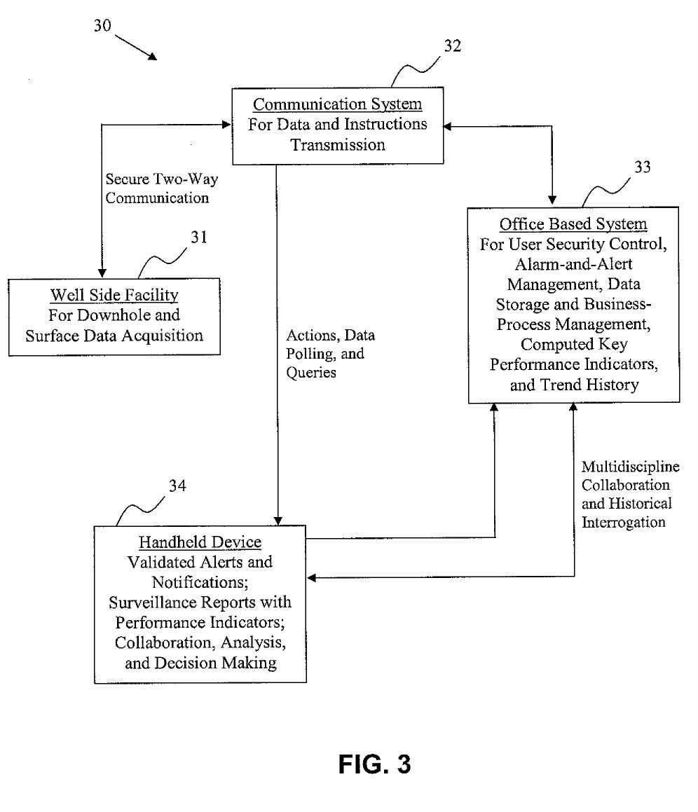

FIG. 3 shows an example of a workflow in accordance with one embodiment of the invention. As shown in FIG. 3, a workflow 30 involves data acquisition at a well site 31. The data acquisition may be performed with one or more monitors or sensors in the well, in the formation, or on the surface at the well site. These data are then transmitted, via a communication system 32, to an office-based system 33, where the data will be processed or stored. The communication my involve secure two-way communication, either wired or wireless communication. The office-based system 33 may have programs/processes to provide the following services: user security control, alarm and alert management, data storage and business process management, and computation of key performance indicators and trend history. Based on the computation at the office-based system 33, if an alarm condition is found, the office-based system 33 may send an alert message to a field operator to take actions.

The validated alerts and notifications may be sent from the office-based system 33 to a handheld device 34 (e.g., a potable computer, a pocket PC, Palm, smart phone, or the like) to alert the user or experts in the field to take actions. That is, a system of the invention is alarm driven—i.e., the actions to be taken by the user at a remote site are triggered by alarm. In order to make the system more efficient, a handheld device (or portable device) 34 of the invention is enabled to perform surveillance of the oilfield operations and other functions, such as surveillance reports with performance indicators, collaboration, analysis and decision making. In addition, the handheld device 34, in cooperation with the office based system 33, may also perform, for example, multidiscipline collaboration and historical interrogation.

Note that in accordance with such an embodiment, the surveillance functions, including generating surveillance reports wither performance indicators, collaboration analysis, and decision making are assigned to the handheld device 34. There is no need to have other operators (see 25 in FIG. 2) involved in the process.

The expert or client may survey the production data with their pocket device when the alarm messages arrive in anytime and anywhere. The user or expert in the field may invoke production control without the need to cycle again through the office based system. By cutting out the reliance on additional operators (as in the prior art workflow), the workflow of the invention is more efficient and the remote user can have sufficient data to make intelligent decisions in a more timely fashion.

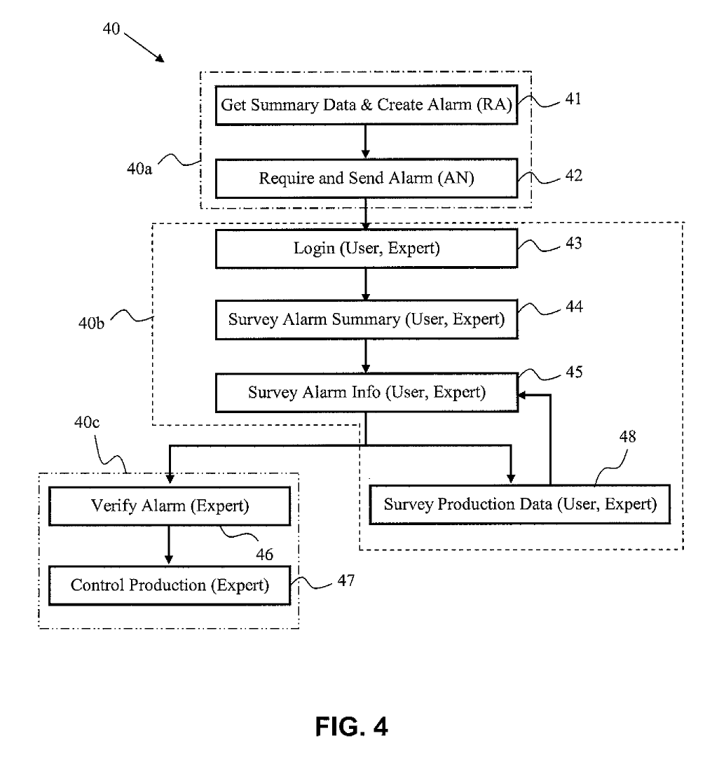

FIG. 4 shows a flow chart illustrating a method 40 of using pocket devices to survey, monitor, and control production data in real time in accordance with one embodiment of the invention. The method 40 may be divided into three major functional blocks: Alarm Notification Process 40a, Alarm Survey Process 40b, and Alarm Verification Process 40c.

The Alarm Notification Process 40a, for example, may comprise a report agent (RA) 41 and an alarm notification service (AN) 42. The report agent (RA) 41 may fetch the real time production data from the real time database and then calculate the data. For example, the report agent (RA) 41 may take the real time data and compare them with preset criteria of the production parameters to see whether all parameters are within the defined ranges or to see whether any parameter is trending in a particular manner. If based on these calculation or comparison, the report agent (RA) 41 determines that an alarm situation has arisen, the system will create an alarm and forward it to the Alarm Notification Service (or process) to notify the appropriate personnel, such as a field user.

An Alarm notification service (AN) 42 typically would register the alarm in a database and send the alarm to a user's pocket device by any suitable means, such as email or text messaging (e.g., SMS).

Once the alarm is sent to and received by a user or an expert in the field, the user or expert will take actions. In accordance with embodiments of the invention, the handheld devices at the field users are designed to have the capability to perform various functions. For example, the user may want to check back to the office-based system to get more information about the alarm conditions and/or the production data in order to take proper actions. For this, systems of the invention may provide an alarm survey service, which will allow the users to survey the alarm situations and/or survey the production data

As shown in FIG. 4, an Alarm Survey Process 40b, which may be implemented on an office-based system, for example, may comprise Login service 43, Survey Alarm Summary service 44, Survey Alarm Info service 45, and Survey Production Data service 48.

Before the users or expert are allowed to access information in the database, Login service 43 authenticates the user or experts. When they login to the office-based system using their pocket devices, the Login service 43 checks their login names and passwords or other authentication criteria against those stored in the database. Only after the usernames and passwords match those in the database would the users or experts be given access to the system.

Once the users or experts are authenticated, Survey Alarm Summary service 44 allows the users or experts to survey the summary of the alarm in their managed fields and/or wells using their pocket devices. This service will allow an user or expert to get a quick idea of what the alarm is about and take necessary action if warranted.

If more detailed information about the alarm is desired or necessary, the Survey Alarm Information service 45 would allow the users or experts to survey the detail information of the alarm and the data related to the alarm conditions using their pocket devices. This service allows the users or experts to have more information in order to make intelligent decisions.

After consulting the systems for more details about the alarm, the user may decide that he needs to examine or analyze the production data. Alternatively, the user may decide that the alarm condition should be verified by an expert in the field.

If examination of production data is needed, the workflow provides a Survey Production Data service 48, which allows the users or experts to survey the real time production data using their pocket devices.

If the alarm condition needs to be verified, in accordance with embodiments of the invention, an alarm verification service may be implemented for this purpose. As shown in FIG. 4, an Alarm Verification Process 40c may comprise an Alarm verification service 46 and a Production Control service 47.

The Alarm Verification service 46 allows the experts to choose an alarm and survey the alarm verification information and verify them using their pocket device. This feature may be available to the experts only. The terms “user” and “expert” are used to indicate different types (e.g., authorization levels) of users of the systems. The experts may be given more access to the systems, while the users may be given limited access.

After verification of the alarm, the experts may decide that production conditions need to be altered, e.g., pumping faster or slower in certain wells. The Production Control service 47 may allow the experts to survey the production or control the production devices with their pocket devices. This feature may be available to the experts only.

By having the handheld devices to perform the more sophisticated functions than simple alarm receipt, the experts in the field can obtain more details about the alarm, query the production data, verify the alarm based on the more detailed information, and survey the production or control the production if necessary.

Advantages of embodiments of the invention may include one or more of the following: (1) Immediate response of the real time production alarm “anywhere and anytime,” using pocket (portable) devices, such as pocket pc, palm and smart phones, to achieve fast communication via wireless networks, for example; (2) Simplified workflow for simple production alarm; and (3) An easier way to visualize and analyze production data on various handheld devices at different resolutions.

By reducing the time from data acquisition to decision making through data surveillance in real time using the integrated pocket devices “anywhere and anytime,” the operators not only can react more quickly to production alarms to improve asset profitability, but also can be more proactive in taking steps to optimize future operations by being able to predict future production performances. Therefore, by using pocket devices to survey data in real time, the systems and methods of the invention save time and costs, as compared with the conventional workflow.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for real-time data surveillance in an oilfield operation, comprising:
a data collection system deployed at a well site for collecting oilfield data;
an office-based computer system for storing and analyzing the oilfield data;
a portable device, wherein the portable device includes at least one program for communicating with the office-based computer system, for surveying the oilfield data stored in the office-based computer system, and for causing the office-based computer system to perform a process implemented on the office-based computer system; and
a communication system providing communication links among the data collection system, the office-based computer system, and the portable device.

2. The system of claim 1, wherein the office-based computer system includes a program for generating and sending an alarm message to the handheld device based on the collected oilfield data.

3. The system of claim 1, wherein the at least one program on the handheld device contains instructions for requesting information about the alarm message from the office-based computer system.

4. The system of claim 1, wherein the at least one program on the handheld device contains instructions for surveying the oilfield data.

5. The system of claim 1, wherein the at least one program on the handheld device contains instructions for validating an alarm condition.

6. The system of claim 1, wherein the at least one program on the handheld device contains instructions for controlling an outfield operation.

7. The system of claim 6, wherein the oilfield operation is oil or gas production.

8. A method for real-time data surveillance in an oilfield operation, comprising:
receiving an alarm message on a portable device, wherein the alarm message is sent from an office-based computer system;
interrogating, using the portable device, a database stored in the office-based computer system;
sending from the handheld device, based on results from the interrogating, a response from the portable device to a well site to control the oilfield operation or to the office-based computer system.

9. The method of claim 8, wherein the interrogating the database comprises obtaining details of the alarm message.

10. The method of claim 8, wherein the interrogating the database comprises surveying data collected from the oilfield operation.

11. The method of claim 10, wherein the data are production data

12. The method of claim 8, wherein the interrogating the database comprises obtaining details of the alarm message.
